(19) United States
(12) Patent Application Publication
(10) Pub. No.: US 2026/0242605 A1
(43) Pub. Date: Aug. 20, 2026

(54) SINGLE-USE PRODUCTS

(71) Applicant: Upcycle Holding B.V., Maastricht (NL)

(72) Inventor: Bas Carolus Johannes LATTEN, Maastricht (NL)

(73) Assignee: Upcycle Holding B.V., Maastricht (NL)

(21) Appl. No.: 19/477,935

(22) PCT Filed: Apr. 26, 2024
(86) PCT No.: PCT/EP2024/061606

§ 371 Date: Oct. 23, 2025

(30) Foreign Application Priority Data
Apr. 26, 2023 (EP) 23170162.4
Jul. 6, 2023 (EP) 23184007.5

(51) Int. Cl. C08L 97/02; A47G 19/00; A47G 21/00; C08L 67/02; C08L 67/04

(52) U.S. Cl. CPC C08L 97/02; C08L 67/02; C08L 67/04; A47G 19/00; A47G 21/00; C08L 2201/06

(57) ABSTRACT

The present invention concerns single-use products made from composite materials, processes of making the single use products as well as pre-mixes that may be employed in such processes. The present inventors have developed a composite material comprising a combination of non-wood lignocellulosic material and a biodegradable and/or compostable polyester, preferably polyhydroxyalkanoate. These composites can be processed into shaped articles, such as cups, plates, straws, cutlery, etc. that possess functional properties adequate to replace conventional SUPs produced from petrochemical based plastics. The lignocellulosic material can be sourced as a by-product from agricultural food production. Production of the present composite materials and processing it into shaped (single use) articles is straight forward, can be carried out using conventional machinery, consumes relatively low amounts of energy, chemicals and/or water.

### FIELD OF THE INVENTION

The present invention is in the field of single-use products. More in particular, the invention concerns single-use products made from composite materials, which may aid in reducing the environmental impact of so-called single-use products. The invention also concerns new processes of making the single use products as well as pre-mixes that may be employed in such processes.

### BACKGROUND OF THE INVENTION

The term single-use plastic or SUP is used to denote products that are used once, or for a short period of time, and are immediately disposed of after use. Examples of single-use plastic products most frequently encountered include packaging, shopping bags, disposable tableware, etc. Single-use plastics are still made primarily from fossil fuel-based chemicals (petrochemicals).

The impact of single use plastic waste on the (global) environment and human health is substantial. The vast majority of petrochemical based plastics don't break down or only extremely slowly; they just break up. Over time, sun and heat slowly turn plastics into smaller and smaller pieces until they eventually become what are known as microplastics. These microscopic plastic fragments, typically no more than 5 millimeters long, are hard to detect and they are just about everywhere. They end up in soil, ground water, rivers and oceans and they enter the food chain when ingested by fish and wildlife, to end up in human bodies. Recent evidence shows this may even lead to heart attacks, stroke and death. For wildlife, plastic waste and microplastics can be particularly dangerous; when eaten they can easily accumulate inside an animal's body and cause health issues, like punctured organs or fatal intestinal blockages. The majority of this pollution—dominated by single-use plastic waste—comes from countries lacking infrastructure to properly manage waste.

Over the past two decades attempts have been made to mitigate the problems associated with the use of (petrochemical based) SUPs. It has proven challenging to find/develop alternative materials for making single use products, that meet all the (functional) requirements, such as (depending on the specific type of product): strength, durability (when wetted), low permeability to fluids, resistance to heat, surface properties, etc. Some promising results have been attained with so-called ‘bioplastics’, which are made up of polymers obtained or synthesized from vegetative materials. For example, sugar cane can be processed to produce ethylene, which can then be used to manufacture polyethylene. However, although biobased, such plastics are still not biodegradable or compostable, hence they don't change the problem of plastic waste accumulating in the environment. Alternatively, starch can be processed to produce lactic acid and subsequently polylactic acid (PLA), which are biodegradable when composted under well-controlled, industrial conditions. These bioplastics can be used to produce single use products that are less harmful to the environment and (human) health. These bioplastics are attractive to businesses for reasons beyond the reduction of plastic pollution: by using bio-based plastics, companies become less reliant on petrochemical materials and the accompanying fluctuations in the prices of oil around the world.

Many bioplastics also have disadvantages. For instance, processes to extract and/or synthesize polymers from vegetative materials are often characterized by significant expenditure of energy, use of chemicals and/or generation of large waste streams. Furthermore, the use of certain bioplastics, such as those based on starch, will compete for systemic resources with food availability (or contribute to further deforestation of land). Finally, certain bioplastics are degradable and/or compostable only under properly controlled conditions at an industrial composting facility. If the products made of such bioplastics are sent to a landfill (or just left behind in the natural environment) degradation will still take very long. Hence, these products are not a very effective solution to the problems associated with SUPs, particularly not in countries/regions lacking the infrastructure to properly manage waste.

It is an object of the present invention to provide new single use products, made up of a material possessing desirable functional properties while overcoming some or all of the drawbacks associated with bioplastics (and petrochemical based plastics).

### SUMMARY OF THE INVENTION

To this end, the present inventors have developed a composite material comprising a combination of non-wood lignocellulosic material and a biodegradable and/or compostable polyester, preferably polyhydroxyalkanoate. These composites can be processed into shaped articles, such as cups, plates, straws, cutlery, etc. that possess functional properties adequate to replace conventional SUPs produced from petrochemical based plastics.

For instance, the present composite materials yield products that have the strength, rigidity and durability typically required to hold liquids and/or moist food products, even when served hot. The composite materials of the invention can be made to have a smooth and hard surface that does not start to deteriorate immediately upon wetting. A drinking straw made of the present composite material, for instance, confers significant advantages over paper drinking straws that are nowadays commonly used as substitute for the plastic straws.

The shaped articles made of the present composite materials degrade under industrial as well as soil composting conditions and, as such, will not result in the formation of (plastic) microparticles that persist in the ecosystem (and accumulate in the food chain). In preferred embodiments, shaped articles made of the present composite materials also degrade under fresh water or marine environment conditions.

Although the properties of the present composite materials and of the shaped articles produced therefrom, are particularly advantageous for application in/as SUPs, the invention is not in any way limited in that regard. Those skilled in the art will understand, based on the present teachings, that the present composite materials may also be used to produce shaped articles that are actually intended for multi-uses, i.e. reusable products, and that shaped articles produced in accordance with the present teachings may be suitable or intended for multi-uses (reusable), without departing from the scope of the invention in any way.

The lignocellulosic material that makes up a significant part of the composite materials of the present invention typically can be obtained from agricultural production of many food products and ingredients, such as grains, legumes, corn, rice, sugar cane, soy, etc., where lignocellulosic plant parts are typically obtained as a waste material. Lignocellulosic agricultural waste is still highly abundant and its utilization for producing composite materials in accordance with the present invention is unlikely to interfere with food production and/or to compete with other production systems.

Production of the present composite materials and processing it into shaped (single use) articles is surprisingly straight forward, can be carried out using conventional machinery, consumes relatively low amounts of energy, chemicals and/or water and, as such, does not produce large waste streams that are problematic to handle.

The present invention thus provided shaped articles made of the present composite materials, processes of producing said shaped articles and composite pre-mixes that can be processed into shaped articles. These and other aspects of the invention will become apparent to those skilled in the art on the basis of the following detailed description and the appending examples.

### DETAILED DESCRIPTION OF THE INVENTION

In a first aspect, the present invention provides a shaped article comprising a three dimensional monolithic body consisting of a composite material comprising a non-wood lignocellulosic material and a biodegradable and/or compostable polyester, preferably polyhydroxyalkanoate.

For the purposes of the present invention, the term “shaped article” is to be understood as meaning any three-dimensional solid article that has acquired a shape, which shape is invariable under normal ambient conditions and/or under normal conditions of use of the article.

The shaped article of the present invention comprises, typically as its main or as its sole part, a monolithic body made up of the composite material. As used herein, the term “monolithic body” is defined as a body that has only one integral piece or part of material and that does not consist of two or more discrete macroscopic layers or portions of material. Accordingly, a “monolithic body” does, for example, not include a multi-layer laminate, although, in principle, it may be part of a multi-layer laminate. As will be understood by those skilled in the art, based on the present teachings, the composite material of the invention confers most or all of the functional properties typically required for many single use products and it can be processed into virtually any shape. Hence, many of the currently envisaged products may simply consist entirely of the monolithic body made up of the composite material, but the invention is not necessarily limited in this regard. In some embodiments of the invention, the shaped article may comprise a plurality of interconnected or mounted parts, including at least one monolithic body made up of the composite material.

In particularly preferred embodiments of the invention, the shaped article is a disposable article or utensil, preferably a disposable article or utensil selected from the group consisting of (drinking) straws; cutlery, such as spoons, forks, knives and chop sticks; plates; drinking cups; lollipop sticks; plant pots, cotton swaps, etc.

The term “composite material” refers to combinations of at least two types of materials, which, in combination confer one or more properties that typically cannot be attained using any of one of the materials individually. Generally speaking, composite materials have a continuous matrix and a discrete load. Without wishing to be bound by any particular theory, it is currently believed that the composite material of the present invention can best be seen/described as a discrete load of non-wood lignocellulosic particles embedded, surrounded and/or held together by a matrix made up of the biodegradable polyester, preferably polyhydroxyalkanoate.

The term “lignocellulosic material” is generally understood to refer to the cell wall material typically making up the majority of non-parenchymal plant tissue and is understood to comprise cellulose, hemicellulose and lignin as its main constituents. The presence of substantial amounts of lignin and the absence of substantial amounts of pectin is what distinguishes lignocellulosic (non-parenchymal) material from the cellulosic material that can be obtained from parenchymal plant tissue. The relative amounts of cellulose, hemicellulose and lignin contained in lignocellulosic materials may vary depending on the source. In addition, as is generally known by those skilled in the art, lignin found in non-wood sources is also structurally different from lignin found in hardwood and/or softwood sources, including the lignin found in the hardened seed shells of these sources. As already indicated herein before, it is particularly preferred in accordance with the invention that the lignocellulosic material is derived from non-woody materials. In an embodiment of the invention, the non-wood lignocellulosic plant material is an agricultural residue from a plant or crop selected from the family of poaceae. In an embodiment of the invention, the non-wood lignocellulosic plant material is an agricultural residue selected from the group consisting of flax, hemp, bagasse, straws of wheat, barley, oats, rye, rice straw, sugar cane, the stalks of maize, cotton, tobacco, bamboo and the husks or shells of grains, rice, etc., preferably the non-wood lignocellulosic plant material is an agricultural residue selected from the group consisting of flax, hemp, straws of wheat, barley, oats, rye, the stalks of maize, cotton, tobacco, bamboo and the husks or shells of wheat, barley, oats, and rye, more preferably the non-wood lignocellulosic plant material is wheat straw. In the context of the present invention, it is also envisaged that two or more non-wood lignocellulosic plant materials may be used in combination.

In an embodiment of the invention, the non-wood lignocellulosic plant material is not selected from sisal, sugarcane bagasse, coconut, piasaba, soybean, jute, ramie and curaua (Ananas lucidiis), rice straw, rice husk, sugarcane and sugarcane bagasse, preferably not selected from rice straw, rice husk, sugarcane and sugarcane bagasse.

As indicated herein before, the composite material comprises particles of the non-wood lignocellulosic plant material, such as particles obtainable by grinding, milling or comminuting the non-wood lignocellulosic plant material. In a preferred embodiment of the invention, the particles of non-wood lignocellulosic plant material are ground, milled or comminuted to a specific particle size range. In a preferred embodiment of the invention, the particles of non-wood lignocellulosic plant material are ground, sieved, milled or comminuted to a specific particle size range. In certain preferred embodiments of the invention, the composite material comprises particles of non-wood lignocellulosic plant material, characterized by a fiber length, within the range of 0.01-10 mm, such as a fiber length of at least 0.2 mm, at least 0.3 mm, at least 0.4 mm or at least 0.5 mm and/or a fiber length of less than 7.5 mm, less than 5 mm, less than 4.5 mm, less than 4 mm, less than 3.5 mm, less than 3 mm or less than 2.5 mm. In certain preferred embodiments of the invention, the composite material comprises particles of non-wood lignocellulosic plant material, characterized by a fiber length, within the range of 0.01-10 mm, such as a fiber length of at least 0.015 mm, at least 0.02 mm, at least 0.03 mm at least 0.05 mm, at least 0.075 mm, at least 0.1 mm, at least 0.2 mm, at least 0.3 mm, at least 0.4 mm or at least 0.5 mm and/or a fiber length of less than 7.5 mm, less than 5 mm, less than 4.5 mm, less than 4 mm, less than 3.5 mm, less than 3 mm or less than 2.5 mm.

In certain preferred embodiments of the invention, the composite material comprises particles of non-wood lignocellulosic plant material, characterized by a fiber length, within the range of 0.01-10 mm, preferably within the range of 0.02-7.5 mm, more preferably within the range of 0.03-3.5 mm, even more preferably within the range of 0.050-3.5 mm, most preferably within the range of 0.050-2.5 mm. Particle size of the materials of the present invention can be determined using visual/microscopic determinations.

As will be understood by those skilled in the art, based on the foregoing, the composite material of the present invention comprises particles of non-wood lignocellulosic material, which have not been subjected to any further treatment, beyond the cutting and size reduction operations. In particular, the non-wood lignocellulosic material has not been subjected to any (chemical) treatments that substantially alter the chemical make-up of the material and/or any (physical/mechanical) treatment that substantially alters the primary, secondary and/or tertiary structure of the lignocellulosic material. Hence, in certain embodiments of the invention, the composite material of the present invention comprises particles of non-wood lignocellulosic material characterized by cellulose, hemicellulose and lignin content similar or identical to that of the plant material from which it is derived, such as a cellulose content within the range of 20-60 wt. %, 25-50 wt. %, or 30-45 wt. %; a hemicellulose content within the range of 10-35 wt. %, 15-30 wt. %, or 20-25 wt. %; and/or a lignin content within the range of 10-30 wt. %, 12.5-25 wt. %, or 15-20 wt. % (all percentages being based on the total weight of the non-wood lignocellulosic material). Furthermore, in certain embodiments of the invention, the composite material of the present invention comprises particles of non-wood lignocellulosic material characterized by the presence of network structures of cellulose, hemicellulose and lignin fibers, which are similar or identical to those found in the plant material from which it is derived.

The composite material further comprises a biodegradable and/or compostable polyhydroxyalkanoate.

The term “polyhydroxyalkanoates” (PHA) as used herein encompasses both homopolymers and copolymers and may refer to a single polyhydroxyalkanoate or a mixture of polyhydroxyalkanoates. To be considered “compostable,” a material must meet the following four criteria: (1) the material must be biodegradable; (2) the material must be disintegrable; (3) the material must not contain more than a maximum amount of heavy metals; and (4) the material must not be ecotoxic. As used herein, the term “biodegradable” generally refers to the tendency of a material to chemically decompose under certain environmental conditions. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

In embodiments, the composite material comprises a biodegradable and/or compostable polyester.

Suitable examples of biodegradable and/or compostable polyester include polybutylene adipate terephthalate (PBAT), polyhydroxyalkanoate (PHA), polybutylene succinate (PBS), polybutylene succinate adipate (PBSA) and mixtures thereof.

Suitable examples of biodegradable and/or compostable polyester include polybutylene adipate terephthalate (PBAT), polyhydroxyalkanoate (PHA), polybutylene succinate (PBS), polybutylene succinate adipate (PBSA), polybutylene succinate terephthalate (PBST) and mixtures thereof.

In embodiments, the biodegradable and/or compostable polyester is polybutylene adipate terephthalate (PBAT), polyhydroxyalkanoate (PHA), polybutylene succinate (PBS) or polybutylene succinate adipate (PBSA).

In embodiments, the biodegradable and/or compostable polyester is polybutylene adipate terephthalate (PBAT), polyhydroxyalkanoate (PHA), polybutylene succinate (PBS), polybutylene succinate adipate (PBSA) or polybutylene succinate terephthalate (PBST).

In a particularly preferred embodiment of the invention the biodegradable and/or compostable polyester is polybutylene adipate terephthalate (PBAT). PBAT is a biodegradable random copolymer, specifically a copolyester of adipic acid, 1,4-butanediol and terephthalic acid. PBAT is for example synthesized by reacting adipic acid and 1,4-butanediol to create their polyester (plus water) and by reacting DMT and 1,4-butanediol to form their polyester as well. The polyesters are then combined to and reacted with tetrabutoxytitanium (TBOT) as a transesterification catalyst, to produce the copolymer of the two previously prepared polymers. This is a random copolymer, because there is no control on the dispersity of the polymer chain lengths or block structuring in the copolymerization reactions; repeat positions are not controlled. A product that can suitably be used in accordance with the present invention is sold by BASF, under the tradename ECOFLEX®.

When used in admixture with one or more other polyesters such as PHA, PBS or PBSA, PBAT is typically in majority proportion in the mixture of polyesters, preferably the mixture comprises PBAT and the (one or more) further polyester(s) at a weight ratio of at least 1/0.75, e.g. at least 1/0.50, at least 1/0.40, at least 1/0.30, at least 1/0.20 or at least 1/0.10 and/or at a ratio of less than 1/0.01, less than 1/0.025, less than 1/0.05 or less than 1/0.10.

When used in admixture with one or more other polyesters such as PHA, PBS or PBSA, PBST, PBAT is typically in majority proportion in the mixture of polyesters, preferably the mixture comprises PBAT and the (one or more) further polyester(s) at a weight ratio of at least 1/0.75, e.g. at least 1/0.50, at least 1/0.40, at least 1/0.30, at least 1/0.20 or at least 1/0.10 and/or at a ratio of less than 1/0.01, less than 1/0.025, less than 1/0.05 or less than 1/0.10.

In preferred embodiments, when the polyester is a PHA, the admixture contains less than 15 wt. % of one or more other polyesters selected from PBAT, polycaprolactone and polylactic acid or combinations thereof based on total (dry) weight of the composite material, preferable less than 10 wt. %, less than 5 wt. %, less than 4 wt. %, less than 3 wt. %, less than 2 wt. % or less than 1 wt. %.

In preferred embodiments, the biodegradable and/or compostable polyhydroxyalkanoate is a homopolymer or copolymer according to formula (I)

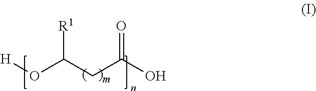

Wherein:
R is in each instance independently selected from the group consisting of hydrogen and C₁-C₁₆ alkyl, preferably from the group consisting of hydrogen and C₁-C₉ alkyl; and
m is in each instance independently selected from 1 to 16, preferably selected from 1 to 2.

In preferred embodiments the total amount of carbons of each monomer present in the polyhydroxyalkanoate according to formula (I) is between 4 and 16.

In preferred embodiments, the biodegradable and/or compostable polyhydroxyalkanoate is a homopolymer or copolymer of one or more monomers selected from the group consisting of 3-hydroxybutyrate (3HB), 4-hydroxybutyrate (4HB), 3-hydroxyvalerate (3HV), 3-hydroxyhexanoate (3HHx), 3-hydroxyheptanoate (3HH), 3-hydroxyoctanoate (3HO), 3-hydroxynonanoate (3HN), 3-hydroxydecanoate (3HD), 3-hydroxyundecanoate (3HUD), 3-hydroxydodecanoate (3HDD).

In preferred embodiments, the biodegradable and/or compostable polyhydroxyalkanoate is a homopolymer of 3-hydroxybutyrate or 4-hydroxybutyrate or a copolymer comprising 3-hydroxybutyrate and/or 4-hydroxybutyrate, preferably a homopolymer of 3-hydroxybutyrate or 4-hydroxybutyrate or a copolymer comprising 3-hydroxybutyrate and 4-hydroxybutyrate, more preferably a homopolymer of 3-hydroxybutyrate or 4-hydroxybutyrate or a copolymer containing 3-hydroxybutyrate and 4-hydroxybutyrate, even more preferably a copolymer containing 3-hydroxybutyrate and 4-hydroxybutyrate.

In particularly preferred embodiments, the biodegradable and/or compostable polyhydroxyalkanoate is a copolymer of 3-hydroxybutyrate and 4-hydroxybutyrate having a 4-hydroxybutyrate content of at least 5 mol %, preferably at least 10 mol %, more preferably at least 15 mol %, even more preferably at least 25 mol %, most preferably at least 30 mol %.

In particularly preferred embodiments, the biodegradable and/or compostable polyhydroxyalkanoate is a copolymer of 3-hydroxybutyrate and 4-hydroxybutyrate having a 4-hydroxybutyrate content of at most 99 mol %, preferably at most 95 mol %, more preferably at most 90 mol %.

In preferred embodiments, the biodegradable and/or compostable polyhydroxyalkanoate is a homopolymer or copolymer selected from the group consisting of poly(3-hydroxybutyrate) (P3HB), poly(4-hydroxybutyrate) (P4HB), poly(3-hydroxyvalerate) (P3HV), poly(3-hydroxyhexanoate) (P3HHx), poly(3-hydroxyheptanoate) (P3HH), poly(3-hydroxyoctanoate) (P3HO), poly(3-hydroxynonanoate) (P3HN), poly(3-hydroxydecanoate) (P3HD), poly(3-hydroxyundecanoate) (P3HUD), poly(3-hydroxydodecanoate) (P3HDD), poly(3-hydroxybutyrate-co-3-hydroxyvalerate) (P3HB3HV), poly(3-hydroxybutyrate-co-3-hydroxyvalerate-co-4-hydroxyvalerate) (P3HB3HV4HV) or P3HB3HV), poly(3-hydroxybutyrate-co-3-hydroxybutyrate) (P3HB4HB), poly(3-hydroxybutyrate-co-3-hydroxyhexanoate) (P3HB3HHx), poly(3-hydroxyoctanoate-co-3-hydroxyhexanoate) (P3HO3HHx), poly(3-hydroxybutyrate-co-3-hydroxyoctanoate) (P3HB3HO), poly(3-hydroxybutyrate-co-3-hydroxydecanoate) (P3HB3HD), preferably selected from the group consisting of poly(4-hydroxybutyrate) (P4HB), poly(3-hydroxyvalerate) (P3HV), poly(3-hydroxyhexanoate) (P3HHx), poly(3-hydroxyheptanoate) (P3HH), poly(3-hydroxyoctanoate) (P3HO), poly(3-hydroxynonanoate) (P3HN), poly(3-hydroxydecanoate) (P3HD), poly(3-hydroxyundecanoate) (P3HUD), poly(3-hydroxydodecanoate) (P3HDD), poly(3-hydroxybutyrate-co-3-hydroxyvalerate-co-4-hydroxyvalerate) (P3HB3HV4HV) or P3HB3HV), poly(3-hydroxybutyrate-co-3-hydroxybutyrate) (P3HB4HB), poly(3-hydroxybutyrate-co-3-hydroxyhexanoate) (P3HB3HHx), poly(3-hydroxyoctanoate-co-3-hydroxyhexanoate) (P3HO3HHx), poly(3-hydroxybutyrate-co-3-hydroxyoctanoate) (P3HB3H0), poly(3-hydroxybutyrate-co-3-hydroxydecanoate) (P3HB3HD).

In preferred embodiments, the biodegradable and/or compostable polyhydroxyalkanoate is selected from the group consisting of poly(3-hydroxybutyrate) (P3HB), poly(4-hydroxybutyrate) (P4HB), poly(3-hydroxybutyrate-co-3-hydroxybutyrate) (P3HB4HB), preferably the biodegradable and/or compostable polyhydroxyalkanoate is poly(3-hydroxybutyrate-co-3-hydroxybutyrate) (P3HB4HB).

In particularly preferred embodiments, the biodegradable and/or compostable polyhydroxyalkanoate is a poly(3-hydroxybutyrate-co-3-hydroxybutyrate) (P3HB4HB) having a 4-hydroxybutyrate content of at least 5 mol %, preferably at least 10 mol %, more preferably at least 15 mol %, even more preferably at least 25 mol %, most preferably at least 30 mol %.

In particularly preferred embodiments, the biodegradable and/or compostable polyhydroxyalkanoate is a poly(3-hydroxybutyrate-co-3-hydroxybutyrate) (P3HB4HB) having a 4-hydroxybutyrate content of at most 99 mol %, preferably at most 95 mol %, more preferably at most 90 mol %.

In embodiments, a composite material according to the invention is provided, comprising a biodegradable and/or compostable polyhydroxyalkanoate and less than 15 wt. % of other polyesters, in particular other polyesters selected from PBAT, polycaprolactone and polylactic acid, based on total (dry) weight of the composite material, preferably less than 10 wt. %, less than 5 wt. %, less than 4 wt. %, less than 3 wt. %, less than 2 wt. % or less than 1 wt. %.

In embodiments, a composite material according to the invention is provided, comprising a biodegradable and/or compostable polyhydroxyalkanoate and less than 15 wt. % of other polyesters, in particular other polyesters selected from PBAT, PBST polycaprolactone and polylactic acid, based on total (dry) weight of the composite material, preferably less than 10 wt. %, less than 5 wt. %, less than 4 wt. %, less than 3 wt. %, less than 2 wt. % or less than 1 wt. %.

Several of the monomers that can be used to produce a polyhydroxyalkanoate contain a chiral centre and, therefore, exist as enantiomers. According to the invention, the chemical structures depicted herein, and therefore the compounds of the invention, encompass all of the corresponding compound's enantiomers. However, as polyhydroxyalkanoates, and therefore also the monomers incorporated therein, are generally produced by microorganisms from naturally occurring resources including sugars, lipids or amino acids, the preferred enantiomer is the enantiomer obtained from the respective naturally occurring resource.

When used in admixture with one or more other polyesters, the polyhydroxyalkanoate is in majority proportion in the mixture of polyesters, preferably the mixture comprises polyhydroxyalkanoate and the (one or more) further polyester(s) at a weight ratio of at least 1/0.75, e.g. at least 1/0.50, at least 1/0.40, at least 1/0.30, at least 1/0.20 or at least 1/0.10 and/or at a ratio of less than 1/0.01, less than 1/0.025 less than 1/0.05 or less than 1/0.10.

In preferred embodiments of the invention, a biodegradable polyester, preferably polyhydroxyalkanoate is used having a melting point within the range of 60-200° C., preferably within the range of 80-175° C., within the range of 90-150° C. or within the range of 100-125° C. Especially in case the bio composite is used to produce an article that will/may come into contact with boiling products or liquids upon the envisaged use, it is preferable that a biodegradable polyester, preferably polyhydroxyalkanoate is selected having a melting point above 100° C.

As will be apparent to the skilled person, based on the present description, the composite material is typically produced and shaped at temperature that exceeds the melting temperature of the polyester, preferably polyhydroxyalkanoate material, which typically results in the polyester material, preferably polyhydroxyalkanoate material, becoming distributed more or less evenly over the surface of the particles of non-wood lignocellulosic material and in the (increased) adhesion of said particles to form a composite material have desired properties.

In certain embodiments of the invention, the composite material comprises the non-wood lignocellulosic material at an amount of at least 35 wt. % by total (dry) weight of the composite material, preferably at least 40 wt. %, at least 45 wt. %, at least 50 wt. %, at least 55 wt. %, at least 60 wt. %, at least 65 wt. % or at least 70 wt. %. The composite material typically comprises the non-wood lignocellulosic material at an amount of less than 99 wt. %, such as less than 95 wt. %, less than 90 wt. %, less than 85 wt. %, or less than 80 wt. %, based on total (dry) weight of the composite material.

In certain embodiments of the invention, the composite material comprises the biodegradable polyester at an amount of at least 1 wt. % by total (dry) weight of the composite material, preferably at least 2.5 wt. %, at least 5 wt. %, at least 7.5 wt. %, at least 10 wt. %, at least 12.5 wt. %, at least 15 wt. %, at least 17.5 wt. % or at least 20 wt. %. The composite material typically comprises the non-wood lignocellulosic material at an amount of less than 65 wt. %, such as less than 50 wt. %, less than 40 wt. %, less than 35 wt. % or less than 30 wt. %, based on total (dry) weight of the composite material.

In certain embodiments of the invention, the composite material comprises the biodegradable polyhydroxyalkanoate at an amount of at least 1 wt. % by total (dry) weight of the composite material, preferably at least 2.5 wt. %, at least 5 wt. %, at least 7.5 wt. %, at least 10 wt. %, at least 12.5 wt. %, at least 15 wt. %, at least 17.5 wt. % or at least 20 wt. %. The composite material typically comprises the biodegradable polyhydroxyalkanoate at an amount of less than 65 wt. %, such as less than 60 wt. %, less than 50 wt. %, less than 45 wt. %, less than 40 wt. %, less than 35 wt. % or less than 30 wt. %, based on total (dry) weight of the composite material.

In certain embodiments of the invention, the composite material comprises the biodegradable polyester and the non-wood lignocellulosic material such that the ratio (w/w) of the biodegradable polyester to the non-wood lignocellulosic material is at least 0.05, such as at least 0.1, at least 0.25, at least 0.40, at least 0.50, at least 0.60 or at least 0.75.

In certain embodiments of the invention, the composite material comprises the biodegradable polyhydroxyalkanoate and the non-wood lignocellulosic material in (relative) amounts such that the ratio (w/w) of the biodegradable polyhydroxyalkanoate to the non-wood lignocellulosic material is at least 0.05, such as at least 0.1, at least 0.25, at least 0.40, at least 0.50, at least 0.60 or at least 0.75.

In certain embodiments of the invention, the composite material comprises the biodegradable polyester and the non-wood lignocellulosic material such that the ratio (w/w) of the biodegradable polyester to the non-wood lignocellulosic material is at most 3, such as at most 2.5, at most 2, at most 1.75, at most 1.5, at most 1.25, at most 1 or at most 0.75.

In certain embodiments of the invention, the composite material comprises the biodegradable polyhydroxyalkanoate and the non-wood lignocellulosic material in (relative) amounts such that the ratio (w/w) of the biodegradable polyhydroxyalkanoate to the non-wood lignocellulosic material is at most 10, such as at most 7.5, such as at most 5, such as at most 2.5, at most 2, at most 1.75, at most 1.5, at most 1.25, at most 1 or at most 0.75. In certain embodiments of the invention, the composite material comprises the biodegradable polyester and the non-wood lignocellulosic material such that the ratio (w/w) of the biodegradable polyester to the non-wood lignocellulosic material is within the range of 0.05-3, such as within the range of 0.1-2.5, within the range of 0.25-2 or within the range of 0.5-1.5.

In certain embodiments of the invention, the composite material comprises the biodegradable polyhydroxyalkanoate and the non-wood lignocellulosic material in (relative) amounts such that the ratio (w/w) of the biodegradable polyhydroxyalkanoate to the non-wood lignocellulosic material is within the range of 0.05-3, such as within the range of 0.1-2.5, within the range of 0.25-2 or within the range of 0.5-1.5.

In certain embodiments of the invention, the non-wood lignocellulosic material and the biodegradable polyhydroxyalkanoate make up at least 90 wt. % of the composite material (based on total dry weight), e.g. at least 92.5 wt. %, at least 95 wt. %, at least 96 wt. %, at least 97.5 wt. %, at least 98 wt. %, at least 99 wt. % or at least 99.5 wt. %. In certain embodiments of the invention, the composite material essentially or completely consists of the combination of on-wood lignocellulosic material and the biodegradable polyhydroxyalkanoate.

In certain embodiments of the invention, the composite material exhibits a biodegradation of at least 60 percent in a period of not more than 45 days, when tested under aerobic composting conditions at a temperature of 58° C. (+/−2° C.) according to ISO 14855-1 (2012). In some cases, they can exhibit a biodegradation of at least 60 percent in a period of not more than 44, or not more than 43, or not more than 42, or not more than 41, or not more than 40, or not more than 39, or not more than 38, or not more than 37, or not more than 36, or not more than 35, or not more than 34, or not more than 33, or not more than 32, or not more than 31, or not more than 30, or not more than 29, or not more than 28, or not more than 27 days when tested under these conditions, also called “industrial composting conditions.” These may not be aqueous or anaerobic conditions. In some embodiments, the composite material can exhibit a total biodegradation of at least about 65, or at least 70, or at least 75, or at least 80, or at least 85, or at least 87, or at least 88, or at least 89, or at least 90, or at least 91, or at least 92, or at least 93, or at least 94, or at least 95 percent, when tested under according to ISO 14855-1 (2012) for a period of 45 days under industrial composting conditions. In some cases, the composite material may exhibit a biodegradation of at least about 91, or at least 92, or at least 93, or at least 94, or at least 95, or at least 96, or at least 97, or at least 98, or at least 99, or at least 99.5 percent within not more than 180 days, or the composite material may exhibit 100 percent biodegradation within not more than 180 days, measured according ISO 14855-1 (2012) under industrial composting conditions. Additionally, or in the alternative, the composite material may exhibit a biodegradation of least 90 percent within not more than about 175, or not more than 170, or not more than 165, or not more than 160, or not more than 155, or not more than 150, or not more than 145, or not more than 140, or not more than 135, or not more than 130, or not more than 125, or not more than 120, or not more than 115, or not more than 110, or not more than 105, or not more than 100, or not more than 95, or not more than 90, or not more than 85, or not more than 80, or not more than 75, or not more than 70, or not more than 65, or not more than 60, or not more than 55, or not more than 50, or not more than 45 days, measured according ISO 14855-1 (2012) under industrial composting conditions. In some cases, the composite material can be at least about 97, 98, 99, or 99.5 percent biodegradable within not more than about 65, or not more than 60, or not more than 55, or not more than 50, or not more than 45 days of testing according to ISO 14855-1 (2012) under industrial composting conditions.

In certain embodiments of the invention, the composite material exhibits a biodegradation of at least 90 percent within not more than 1 year, measured according ISO 14855-1 (2012) under home composting conditions. In some cases, the composite material may exhibit a biodegradation of at least about 91, or at least 92, or at least 93, or at least 94, or at least 95, or at least 96, or at least 97, 9 or at least 8, or at least 99, or at least 99.5 percent within not more than 1 year, or the composite material may exhibit 100 percent biodegradation within not more than 1 year, measured according ISO 14855-1 (2012) under home composting conditions. In some cases, the composite material may exhibit a biodegradation of at least 90 percent within not more than about 350, or not more than 325, or not more than 300, or not more than 275, or not more than 250, or not more than 225, or not more than 220, or not more than 210, or not more than 200, or not more than 190, or not more than 180, or not more than 170, or not more than 160, or not more than or not more than 150, or not more than 140, or not more than 130, or not more than 120, or not more than 110, or not more than 100, or not more than 90, or not more than 80, or not more than 70, or not more than 60, or not more than 50 days, measured according ISO 14855-1 (2012) under home composting conditions. In some cases, the composite material can be at least about 97, or at least 98, or at least 99, or at least 99.5 percent biodegradable within not more than about 70, or not more than 65, or not more than 60, or not more than 50 days of testing according to ISO 14855-1 (2012) under home composting conditions. In certain embodiments of the test of the previous embodiment, the specification regarding significant organic constituents as specified in EN 13432 (2000) (§ A.2.1) and the exemption for materials of natural origin as specified in EN 13432 (2000) (§ 4.3.2) is applicable.

In certain embodiments of the invention, the composite material exhibits a soil biodegradation of at least 60 percent within not more than 130 days, measured according to ISO 17556 (2012) under aerobic conditions at ambient temperature. In some cases, the composite material can exhibit a biodegradation of at least 60 percent in a period of not more than 130, or not more than 120, or not more than 110, or not more than 100, or not more than 90, or not more than 80, or not more than 75 days when tested under these conditions, also called “soil composting conditions.” These may not be aqueous or anaerobic conditions. In some cases, the composite material can exhibit a total biodegradation of at least about 65, or at least 70, or at least 72, or at least 75, or at least 77, or at least 80, or at least 82, or at least 85 percent, when tested under according to ISO 17556 (2012) for a period of 195 days under soil composting conditions. In order to be considered “biodegradable,” under soil composting conditions according to (inter)national standards and regulations, a material typically must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years. The composite material may exhibit a biodegradation of at least 90 percent within not more than 2 years, 1.75 years, 1 year, 9 months, or 6 months measured according ISO 17556 (2012) under soil composting conditions. In some cases, the composite material may exhibit a biodegradation of at least about 91, or at least 92, or at least 93, or at least 94, or at least 95, or at least 96, or at least 97, or at least 98, or at least 99, or at least 99.5 percent within not more than 2 years, or the composite material may exhibit 100 percent biodegradation within not more than 2 years, measured according ISO 17556 (2012) under soil composting conditions. Additionally, or in the alternative, the composite material may exhibit a biodegradation of at least 90 percent within not more than about 700, 650, 600, 550, 500, 450, 400, 350, 300, 275, 250, 240, 230, 220, 210, 200, or 195 days, measured according ISO 17556 (2012) under soil composting conditions. In some cases, the composite material can be at least about 97, or at least 98, or at least 99, or at least 99.5 percent biodegradable within not more than about 225, or not more than 220, or not more than 215, or not more than 210, or not more than 205, or not more than 200, or not more than 195 days of testing according to ISO 17556 (2012) under soil composting conditions. In certain embodiments of the test of the previous embodiment, the specification regarding significant organic constituents as specified in EN 13432 (2000) (§ A.2.1) and the exemption for materials of natural origin as specified in EN 13432 (2000) (§ 4.3.2) is applicable.

In certain embodiments of the invention, the composite material exhibits a biodegradation of at least 90 percent within not more than 56 days, measured according to ISO 14851 (2019) or ISO 14852 (2021) under aqueous aerobic conditions. In some cases, the composite material may exhibit a biodegradation of at least about 91, or at least 92, or at least 93, or at least 94, or at least 95, or at least 96, or at least 97, 9 or at least 8, or at least 99, or at least 99.5 percent within not more than 56 days, or the composite material may exhibit 100 percent biodegradation within not more than 56 days, measured according ISO 14851 (2019) or ISO 14852 (2021) under aqueous aerobic conditions. In some cases, the composite material may exhibit a biodegradation of at least 90 percent within not more than about 55, or not more than 52.5, or not more than 50, or not more than 47.5, or not more than 45, or not more than 42.5, or not more than 40, or not more than 37.5, or not more than 35, or not more than 32.5, or not more than 30, or not more than 27.5, or not more than 25, or not more than or not more than 22.5, or not more than 20, or not more than 19, or not more than 18, or not more than 17, or not more than 16, or not more than 15, or not more than 14, or not more than 13, or not more than 12, or not more than 10 days, measured according to ISO 14851 (2019) or ISO 14852 (2021) under aqueous aerobic conditions. In some cases, the composite material can be at least about 97, or at least 98, or at least 99, or at least 99.5 percent biodegradable within not more than about 45, or not more than 40, or not more than 35, or not more than 25 days of testing according to ISO 14851 (2019) or ISO 14852 (2021) under aqueous aerobic conditions. In certain embodiments of the test of the previous embodiment, the specification regarding significant organic constituents as specified in EN 13432 (2000) (§ A.2.1) and the exemption for materials of natural origin as specified in EN 13432 (2000) (§ 4.3.2) is applicable.

In certain embodiments of the invention, the composite material exhibits a biodegradation of at least 90 percent within not more than 6 months, measured according ASTM D 6691 (2017) under aqueous aerobic conditions in seawater. In some cases, the composite material may exhibit a biodegradation of at least about 91, or at least 92, or at least 93, or at least 94, or at least 95, or at least 96, or at least 97, 9 or at least 8, or at least 99, or at least 99.5 percent within not more than 6 months, or the composite material may exhibit 100 percent biodegradation within not more than 6 months, measured according ASTM D 6691 (2017) under aqueous aerobic conditions in seawater. In some cases, the composite material may exhibit a biodegradation of at least 90 percent within not more than about 175, or not more than 162.5, or not more than 150, or not more than 137.5, or not more than 125, or not more than 112.5, or not more than 110, or not more than 105, or not more than 100, or not more than 95, or not more than 90, or not more than 85, or not more than 80, or not more than or not more than 75, or not more than 70, or not more than 65, or not more than 60, or not more than 55, or not more than 50, or not more than 45, or not more than 40, or not more than 35, or not more than 30, or not more than 25 days, measured according ASTM D 6691 (2017) under aqueous aerobic conditions in seawater. In some cases, the composite material can be at least about 97, or at least 98, or at least 99, or at least 99.5 percent biodegradable within not more than about 70, or not more than 65, or not more than 60, or not more than 50 days of testing according to ASTM D 6691 (2017) under aqueous aerobic conditions in seawater.

In certain embodiments of the invention, the composite material does not comprise substantial amounts of polylactic acid (PLA), e.g. preferably the composite material comprises PLA in amounts less than 5 wt. %, based on the total (dry) weight of the composite, e.g. less than 2.5 wt. %, less than 1 wt. %, less than 0.5 wt. % or less than 0.1 wt. %. In certain preferred embodiments of the invention, the composite material is essentially or completely free from PLA.

In certain embodiments of the invention, the composite material does not comprise substantial amounts of starch or starch based polymers, e.g. preferably the composite material comprises starch and/or starch-based polymers in (combined) amounts of less than 5 wt. %, based on the total (dry) weight of the composite, e.g. less than 2.5 wt. %, less than 1 wt. %, less than 0.5 wt. % or less than 0.1 wt. %. In certain preferred embodiments of the invention, the composite material is essentially or completely free from starch and/or starch-based polymers.

As mentioned herein before, the composite material of the present invention typically confers the strength and stiffness properties typically required for (single use) utensils such as plates, cups, cutlery, etc. Stiffness is one of the key mechanical properties of plastics, along with strength, hardness, and toughness. Stiffness of plastic is the ability of the material to distribute a load and resist deformation or deflection (functional failure). The stiffness of plastics can be expressed as the flexural modulus. The strength of a plastic, typically expressed as the tensile strength, reflects how much stress a plastic can withstand without breaking when it is stretched or pulled (physical failure). Stiffness and strength are often needed in conjunction with one another in demanding applications.

In preferred embodiments, the composite material of the invention has a flexural modulus within the range of 1500-5000 MPa, as determined in accordance with DIN53457, preferably within the range of 2000-4000 MPa, more preferably within the range of 2500-3500 MPa, most preferably within the range of 2700-3100 MPa. In preferred embodiments, the composite material of the invention has a flexural strength within the range of 40-100 MPa, preferably within the range of 50-90 MPa, more preferably within the range of 55-80 MPa, most preferably within the range of 60-70 MPa.

In preferred embodiments, the composite material of the invention has a tensile modulus within the range of 1500 to 4000 MPa, as determined in accordance with DIN53457, preferably within the range of 1800-3500 MPa, more preferably within the range of 2000-3000 MPa, most preferably within the range of 2200-2600 MPa.

In preferred embodiments, the composite material of the invention has a strength at break within the range of 5-25 MPa, as determined in accordance with DIN53455, preferably within the range of 7.5-22.5 MPa, more preferably within the range of 10-20 MPa, most preferably within the range of 12.5-17.5 MPa.

In preferred embodiments, the composite material of the invention has an elongation at break within the range of 0.5-5%, as determined in accordance with DIN53455, preferably within the range of 1-4%, more preferably within the range of 1.25-3%, most preferably within the range of 1.5-2.5%.

Furthermore, the composite material of the present invention typically can be used to produce articles that, upon use, come into direct contact with hot (liquids or (semi) solid) compositions, including, in particular, boiling liquids. Hence, in preferred embodiments of the invention, the composite material is able to resist significant deformation and/or damage at temperature within the range of 80-100° C. In preferred embodiments, the composite material of the invention has a Vicat Softening Temperature (Rate B, 10N), determined in accordance with ASTM D 1525, of above 85° C., more preferably above 87.7° C., still more preferably above 90° C., most preferably above 92.5° C. Furthermore, in preferred embodiments, the composite material of the invention has a Heat Distortion Temperature (Metot B, 0.45 MPa), determined in accordance with ASTM D 648, of at least 70° C., more preferably at least 75° C., still more preferably at least 77.5° C., most preferably at least 80° C.

A second aspect of the invention provides a method of producing a shaped article as defined herein, said method comprising the steps of:
a) providing a quantity of ground/comminuted non-wood lignocellulosic plant material as defined herein before;
b) providing a quantity of a biodegradable or compostable polyester, preferably polyhydroxyalkanoate as defined herein before;
c) mixing said ground/comminuted lignocellulosic plant material and said particulate biodegradable and/or compostable polyester, preferably polyhydroxyalkanoate and converting it into a pumpable mass; and
d) processing said mass into a shaped article.

As will be understood by those skilled in the art, based on the present teachings, step a) may comprise any conventional operation suitable to convert a non-wood lignocellulosic tissue comprising vegetative material, preferably in the form of an agricultural waste product, into a particular composition having the morphological, chemical and physical characteristics as defined hereon before. Such operations will typically comprise one or more cutting and/or grinding steps to attain the desired particle size distribution. Additional steps, such as washing, sieving, removal of debris, etc. may optionally be applied as well. As will be apparent to those skilled in the art, based on the present teachings, it is preferred that the process does not comprise any steps resulting in alterations of the chemical make-up of the material. More in particular, the process does not comprise any steps wherein the lignocellulosic material is treated with chemicals so as to extract certain components, such as acid, base and/or peroxide treatments. As will also be apparent to those skilled in the art, based on the present teachings, it is preferred that the process does not comprise any steps resulting in alterations of the primary, secondary and/or tertiary structure of the lignocellulosic (cell wall) material. More in particular, the process does not comprise any steps wherein the lignocellulosic material is subjected to (high) mechanical shear operations that change the length and/or structure of the fiber components, such as high shear fibrillation treatments.

In accordance with the invention, step c) of the process comprises the conversion of the particulate lignocellulosic material and the polyester, preferably polyhydroxyalkanoate into a pumpable mass. The term ‘pumpable’ as used within the context of the present invention refers to the capability of a composition or mass to flow under an adequate driving force. The driving force required to force the material to flow, e.g. though a tubular system, may be provided by any type of positive displacement pump known in the art, for example, a progressive cavity, piston, gear, lobe, diaphragm, peristaltic, or screw pump, etc. The conversion of peeled raw potato into a pumpable mass can be accomplished by mechanical treatments such as slicing, comminuting, crushing, grinding, cutting, etc. In a preferred embodiment of the invention, a process as defined herein is provided, wherein step c) comprises combining the lignocellulosic material, the biodegradable and/or compostable polyester, preferably polyhydroxyalkanoate while bringing and keeping the mixture to/at a temperature that is above the melting temperature of the polyester, preferably polyhydroxyalkanoate. Typically, in accordance with the invention, the combining and mixing of the particulate lignocellulosic material and the polyester, preferably polyhydroxyalkanoate in molten state yield a pumpable mass and typically does not require the addition of further (liquid) components, such as water. Embodiments are envisaged though wherein some water is added in order to increase followability. In a preferred embodiment of the invention, a process as defined herein is provided, wherein step c) yields a mass having a dry matter content of more than 50 wt. %, based on the total weight of the mass, e.g. more than 75 wt. %, more than 80 wt. %, more than 85 wt. %, more than 90 wt. %, more than 92.5 wt. %, more than 95 wt. %, more than 97.5 wt. %, more than 98 wt. % or more than 99 wt. %.

Typically, step c) of the process comprises bringing and keeping the mixture of the particulate lignocellulosic material and the polyester, preferably polyhydroxyalkanoate to/at a temperature of above 60° C., to above 70° C., to above 75° C., to above 80° C., to above 85° C., to above 90° C., to above 100° C., to above 110° C., to above 120° C., or to above 125° C. Said temperature represents the core temperature, i.e. the temperature that is attained throughout the mass. In preferred embodiments of the invention, the pumpable mass is not exposed to temperatures above 250° C., above 200° C., above 175° C., above 150° C., or above 140° C. Exposing the mixture to very high temperatures for prolonged periods of time may cause undesirable changes to the lignocellulosic material in particular.

Step d) of the process may comprise any suitable operation known to the person skilled in the art. Embodiments are envisaged wherein the pumpable mass is subjected to operations such as die casting, injection molding, blow molding, extrusion molding, etc. The type and shape of the article to be produced will determine which operations are suitable and economically feasible, as will be understood by those skilled in the art. In certain preferred embodiments of the invention, the pumpable mass obtained in step c) is subjected to an extrusion process. The extruder typically acts as a complete processing apparatus in which feeding of the lignocellulosic material and the polyester, preferably polyhydroxyalkanoate into the extruder, kneading/heating, and the shaping of the mass are carried out in one continuous process. In a typical set-up the extruder comprises a barrel equipped with intermeshed co-rotating screws (or counter rotating screws, subject to choice) that cooperate to produce and/or maintain a homogenized mixture that, ultimately, is continuously extruded through a die to produce a shaped product. In the extruder, various regions may be distinguishable, namely: i) one or more feed zones for the lignocellulosic material and the polyester, preferably polyhydroxyalkanoate, ii) a heating (and evaporation) zone, and iii) a forming zone. In the feed zone, the lignocellulosic material and the polyester, preferably polyhydroxyalkanoate are fed into the head of the extruder (remote from the die). In the heating zone, the mass is heated. In the forming zone, the mass is forced through a die. Preferred embodiments make use of a twin-screw extruder (TSE) because of the improved mixing, gentler processing and improved kneading capabilities. TSEs also benefit from the fact that, in comparison to single screw extruders, they provide greater process control and positively convey the material between the flights and elements on the screws. Generally, temperature control (including temperature maintenance) may be achieved through the use of external heaters strategically located along zones of the extruder. The extrusion pressure typically depends on the materials used, e.g. on the selection of the polyester, preferably polyhydroxyalkanoate, the particle size of the lignocellulosic material, the ratio of lignocellulosic material to polyester, preferably polyhydroxyalkanoate, the use of additional liquid, etc., the temperature of the extruding mass, the rate at which the lignocellulosic material and polyester, preferably polyhydroxyalkanoate are fed to the extruder, the extrusion velocity, and the like. In accordance with preferred embodiments of the invention, the process is carried out in such a way that that the mass undergoes a pressure drop of at least 0.5 MPa, e.g. at least 1 MPa, at least 2 MPa, at least 3 MPa, at least 4 MPa or at least 5 MPa. Typically, the process is carried out in such a way that that the mass undergoes a pressure drop of less than 8 MPa, less than 7 MPa, less than 6 MPa or less than 5 MPa.

The product coming out of the extruder is preferably cut into pieces as it leaves the extruder so that individual/discrete pieces are formed during expansion. For this purpose a rotating blade may be located adjacent the extruder die to cut the emerging flow of extrudate into pieces of the desired size and shape.

In accordance with certain embodiments, a process as defined in the present disclosure is provided, wherein step d) is followed by one or more further treatment steps, such as drying and/or cooling steps. As will be understood by those skilled in the art, based on the present teachings, a shaped body can be obtained using the processes described herein, which may constitute the shaped article per se (i.e. an article that is ready-for-use) or which may be combined with other components or materials so as to produce the desired article. The extrusion process, as disclosed herein is particularly suitable for the production of rod-shaped or tubular products, such as drinking straws, lollipop sticks, cotton swap stick, chop sticks, etc.

A further aspect of the invention concerns products obtainable by any of the processes as defined herein. Whenever, in this document, reference is made to the ‘shaped article’ and/or the ‘monolithic body’ (consisting of the composite material) this refers to the product as described herein on the basis of structural/chemical characteristics as well as to the products obtainable by the process described herein, which may be the same or different products, as will be understood by those skilled in the art, on the basis of the present teachings. In particular, a property may be inherent to products obtained using the process described herein, without said property being described herein in an explicit way.

A further aspect of the invention concerns product in the form of a granulate, pelletized composition or free flowing powder comprising a combination of:
a non-wood lignocellulosic material, said material being obtainable by grinding, milling or macerating non-wood lignocellulosic plant material, as defined herein before; and
a biodegradable and/or compostable polyester, preferably polyhydroxyalkanoate, as defined herein before.

Such products constitute a ‘pre-mix’ for the production of shaped articles in accordance with the present invention. As will be apparent to those skilled in the art, based on the present teachings, such pre-mixes may be processed into shaped articles by subjecting them to heating, mixing/kneading and a shaping operation. The preferred characteristics of the particulate non-wood lignocellulosic material and the particulate biodegradable and/or compostable polyester, preferably polyhydroxyalkanoate that make up said granulate are in accordance with the disclosure herein of the shaped articles and the processes of making them, as will be apparent to those skilled in the art. In accordance with specific embodiments of the invention individual particles, granules or pellets, contained within the pre-mix are comprise a combination of the non-wood lignocellulosic material and the biodegradable and/or compostable polyester, preferably polyhydroxyalkanoate, i.e. in the form of a composite. Such composite particles, granules or pellets may be produced by mixing the non-wood lignocellulosic material in particular form and the biodegradable and/or compostable polyester, preferably polyhydroxyalkanoate at a temperature above the melting temperature of the polyester, preferably polyhydroxyalkanoate and converting the mass into composite particles, granules or pellets, by any suitable means, such as by extruding the mass, cooling it and subjecting it to a grinding or cutting operation, typically after cooling of the extrudate. In accordance with specific embodiments of the present invention, said pre-mix is characterized by having a melting temperature range of 100-250° C., more preferably 125-225° C., most preferably 140-200° C. In accordance with specific embodiments of the present invention, said pre-mix is characterized by having a melt flow index (230° C./10 kg) of 0.05-1 g/10 min., as determined in accordance with ISO1133, preferably within the range of 0.075-0.75 g/10 min., more preferably within the range of 0.1-0.5 g/10 min, most preferably within the range of 0.15-0.25 g/10 min. These values ascertain good processibility, especially in extrusion processes.

In accordance with specific embodiments of the present invention, said pre-mix is characterized by displaying limited mould shrinkage, such as a mould shrinkage percentage of 0.5-2%, preferably 0.7-1.5, most preferably 0.8-1.25%.

Unless otherwise defined, all terms used in disclosing the invention, including technical and scientific terms, have the meaning as commonly understood by one of ordinary skill in the art to which this invention belongs.

“A”, “an”, and “the” as used herein refer to both singular and plural forms unless the context clearly dictates otherwise. By way of example, “a compartment” refers to one or more than one compartment.

“About” as used herein referring to a measurable value such as a parameter, an amount, a temporal duration, and the like, is meant to encompass variations of +/−10% or less, more preferably +/−5% or less, even more preferably +/−1% or less of and from the specified value, in so far such variations are appropriate to perform in the disclosed invention. However, it is to be understood that the value to which the modifier “about” refers is itself also specifically disclosed.

“Comprise”, “comprising”, “comprises” and “comprised of” as used herein are synonymous with “include”, “including”, “includes” or “contain”, “containing”, “contains” and are inclusive or open-ended terms that specify the presence of what follows, e.g. a component, and do not exclude or preclude the presence of additional, non-recited components, features, element, members, steps, known in the art or disclosed therein.

The recitation of numerical ranges by endpoints includes all numbers and fractions subsumed within that range, as well as the recited endpoints. The skilled person will appreciate that the present invention can incorporate any number of the specific features described above.

Throughout this text, the use of terms in brackets, usually means that the term within brackets specifies a possible option or a possible meaning and should thus not be considered limiting.

Advantages of the invention will become apparent from the following examples, which are given below as mere illustrations, and are non-limitative.

Particularly preferred embodiments of the present invention include the following:

Embodiment 1: Shaped article comprising a three dimensional monolithic body consisting of a composite material comprising a non-wood lignocellulosic material and a biodegradable and/or compostable polyhydroxyalkanoate, wherein the composite material comprises the biodegradable and/or compostable polyhydroxyalkanoate at an amount of less than 90 wt. % based on total (dry) weight of the composite material and the non-wood lignocellulosic material and the biodegradable and/or compostable polyhydroxyalkanoate together make up at least 92.5 wt. %, preferably at least 95 wt. %, more preferably at least 97.5 wt. % of the composite material.

Embodiment 2: Shaped article according to embodiment 1, wherein the non-wood lignocellulosic material comprises network structures of cellulose, hemicellulose and lignin fibers.

Embodiment 3: Shaped article according to embodiment 1 or 2, wherein the non-wood lignocellulosic material comprises particles obtainable by grinding, milling or comminuting non-wood lignocellulosic plant material.

Embodiment 4: Shaped article according to embodiment 3, wherein the non-wood lignocellulosic plant material is an agricultural residue selected from the group consisting of flax, hemp, bagasse, straws of wheat, barley, oats, rye, rice straw, sugar cane, the stalks of maize, cotton, tobacco, bamboo and the husks or shells of grains, rice, etc., preferably straws of wheat.

Embodiment 5: Shaped article according to any one of the preceding embodiments, wherein the composite material comprises 40-99 wt. % by total weight of the composite material, of the non-wood lignocellulosic material, preferably 55-95 wt. %, more preferably 60-90 wt. %.

Embodiment 6: Shaped article according to embodiment 1, wherein the composite material does not comprise polylactic acid (PLA).

Embodiment 7: Shaped article according to embodiment 1, wherein the composite material does not comprise starch.

Embodiment 8: Shaped article according to embodiment 1, wherein the biodegradable and/or compostable polyhydroxyalkanoate is a homopolymer of 3-hydroxybutyrate or 4-hydroxybutyrate or a copolymer comprising 3-hydroxybutyrate and/or 4-hydroxybutyrate, preferably a homopolymer of 3-hydroxybutyrate or 4-hydroxybutyrate or a copolymer comprising 3-hydroxybutyrate and 4-hydroxybutyrate, more preferably a homopolymer of 3-hydroxybutyrate or 4-hydroxybutyrate or a copolymer containing 3-hydroxybutyrate and 4-hydroxybutyrate, even more preferably a copolymer containing 3-hydroxybutyrate and 4-hydroxybutyrate, most preferably a copolymer of 3-hydroxybutyrate and 4-hydroxybutyrate having a 4-hydroxybutyrate content of at least 30 mol %.

Embodiment 9: Shaped article according to any one of the preceding embodiments, wherein the composite material comprises the biodegradable and/or compostable polyhydroxyalkanoate at an amount between 1-60 wt. %, preferably 5-45 wt. %, more preferably 10-40 wt. % based on total (dry) weight of the composite material.

Embodiment 10: Shaped article according to any one of the preceding embodiments, having one or more of the following biodegradability characteristics:
biodegradation of at least 90% within a period of not more than 180 days, measured according to ISO 14855-1 (2012) under industrial composting conditions;
biodegradation of at least 90% within a period of not more than 2 years, measured according to ISO 17556 (2012) under soil compositing conditions; and
biodegradation of at least 90% within a period of not more than 1 year measured according to ISO 14855-1 (2012) under home composting conditions

Embodiment 11: Shaped article according to any one of the preceding embodiments, wherein the article is a disposable article or utensil, preferably a disposable article or utensil selected from the group consisting of (drinking) straws; cutlery, such as spoons, forks, knives, chop sticks; plates; drinking cups; lollipop sticks; plant pots, cotton swaps, etc.

Embodiment 12: Product in the form of a granulate, a free flowing powder or a pelletized composition, said product comprising a combination of:
a particulate non-wood lignocellulosic material, said material being obtainable by grinding, milling or macerating non-wood lignocellulosic plant material; and
a particulate biodegradable and/or compostable polyhydroxyalkanoate,
   wherein the composite material comprises the biodegradable and/or compostable polyhydroxyalkanoate at an amount of less than 90 wt. % based on total (dry) weight of the composite material and the non-wood lignocellulosic material and the biodegradable and/or compostable polyhydroxyalkanoate together make up at least 92.5 wt. %, preferably at least 95 wt. %, more preferably at least 97.5 wt. % of the granulate or powder.

Embodiment 13: Method of producing a shaped article as defined in any one of embodiments 1-11, said method comprising the steps of:
a) providing a quantity of ground/comminuted non-wood lignocellulosic plant material;
b) providing a quantity of a biodegradable and/or compostable polyhydroxyalkanoate;
c) mixing said ground/comminuted lignocellulosic plant material and said particulate biodegradable and/or compostable polyhydroxyalkanoate and processing it into a pumpable mass; and
d) processing said mass into a shaped article.

Embodiment 14: Method according to embodiment 13, wherein step a) comprises providing a quantity of non-wood lignocellulosic plant material and processing it with a grinder, mill, sieve, compounder, etc., to obtain a ground/comminuted material characterized by a fiber length within the range of 0.05-3.5 mm.

Embodiment 15: Method according to any one of embodiments 13-14, wherein step d) comprises die casting, injection molding, blow molding or extrusion molding of the pumpable mass.

Embodiment 16: Method according to any one of embodiments 13-15, wherein the pumpable mass is heated during steps c) and/or d), preferably to a temperature above the melting point of the biodegradable and/or compostable polyhydroxyalkanoate and/or to a temperature within the range of 60-160° C., more preferably to a temperature within the range of 70-150° C., most preferably to a temperature within the range of 80-140° C.

Embodiment 17: Shaped article obtainable by the process as defined in any one of embodiments 13-16.

### EXAMPLES

### Example 1: Manufacture of Compostable Single Use Article According to the Invention

### 1.1 Compounding of Lignocellulosic Material and P(3HB)

A pre-mix in accordance with the invention is produced, by combining 50 w % of shredded wheat straw material (processed into particles characterized by a fiber length within the range of 0.5-3.5 mm) and 50 w % of P(3HB) (ENMAT Y3000P). Compounding is done using a co-rotating twin screw extruder equipped with LWF feeders, to dose the required amounts of material into the extruder, a side-feeder to add the wheat into the process and a vacuum vent to remove volatiles. The screw design, to take care for melting the polymer and to disperse the wheat, includes a light melting zone to avoid degradation of the polymer and a light mixing zone for the dispersion of the wheat and avoid degradation of the compound. During compounding the temperature in the mixing zone is set to 160° C. Subsequently, the compound is pelletized by passing it through an air cooling unit followed by treatment with a rotating knife.

### 1.2 Manufacture of Single Use Article by Injection Moulding

This pre-mix material is then processed into compostable single use article (cutlery) by an injection moulding process, wherein the pre-mix is heated to a temperature of 190° C. (to produce a mass that is sufficiently flowable for the injection moulding operation). The shaped article obtained accordingly has good optical properties. The shaped article is subjected to various tests, with the following results.

Shaped composite - Technical properties

| Mechanical properties | Standard method | Value | Unit |
|---|---|---|---|
| Tensile strength at break | DIN53455 | 5.09 | MPa |
| Elongation at break | DIN53455 | 2.73 | % |
| Tensile modulus | DIN53457 | 1972 | MPa |

### Example 2: Manufacture of Compostable Single Use Article According to the Invention

### 2.1 Compounding of Lignocellulosic Material and P(3HB3HV)

A pre-mix in accordance with the invention is produced, by combining 50 w % of shredded wheat straw material (processed into particles characterized by a fiber length within the range of 0.05-3.5 mm) and 50 w % of P(3HB3HV) (M-Vera GP1045). Compounding is done using a co-rotating twin screw extruder equipped with LWF feeders, to dose the required amounts of material into the extruder, a side-feeder to add the wheat into the process and a vacuum vent to remove volatiles. The screw design, to take care for melting the polymer and to disperse the wheat, includes a light melting zone to avoid degradation of the polymer and a light mixing zone for the dispersion of the wheat and avoid degradation of the compound. During compounding the temperature in the mixing zone is set to 160° C. Subsequently, the compound is pelletized by passing it through an air cooling unit followed by treatment with a rotating knife.

### 2.2 Manufacture of Single Use Article by Injection Moulding

This pre-mix material is then processed into compostable single use article (cutlery) by an injection moulding process, wherein the pre-mix is heated to a temperature of 190° C. (to produce a mass that is sufficiently flowable for the injection moulding operation). The shaped article obtained accordingly has good optical properties. The shaped article is subjected to various tests, with the following results.

Shaped composite - Technical properties

| Mechanical properties | Standard method | Value | Unit |
|---|---|---|---|
| Tensile strength at break | DIN53455 | 4.02 | MPa |
| Elongation at break | DIN53455 | 4.20 | % |
| Tensile modulus | DIN53457 | 1563 | MPa |

### Example 3: Compounding of Lignocellulosic Material and PBAT

A pre-mix in accordance with the invention is produced, by combining 45 w % of shredded wheat straw material (processed into particles characterized by a fiber length within the range of 0.05-3.5 mm) and 55 w % of PBAT (Ecoflex® F blend A1200 ex BASF). Compounding is done using a co-rotating twin screw extruder equipped with LWF feeders, to dose the required amounts of material into the extruder, a side-feeder to add the wheat into the process and a vacuum vent to remove volatiles. The screw design, to take care for melting the polymer and to disperse the wheat, includes a light melting zone to avoid degradation of the polymer and a light mixing zone for the dispersion of the wheat and avoid degradation of the compound. During compounding the temperature in the mixing zone is set to 160° C. Subsequently, the compound is pelletized by passing it through an air cooling unit followed by treatment with a rotating knife. The pelletized pre-mix has the following properties.

Pre-mix - Technical properties

| Physical properties | Standard method | Value | Unit |
|---|---|---|---|
| Melt flow index | ISO1133 | 0.2 | g/10 min. |
| (230° C./10 kg) | | | |
| Density | DIN53479 | 1.32 | g/cm³ |

### Example 4: Manufacture of Compostable Single Use Article According to the Invention (by Injection Moulding)

The pre-mix material according to example 3, is processed into compostable single use article (cutlery) by an injection moulding process, wherein the pre-mix is heated to a temperature of 190° C. (to produce a mass that is sufficiently flowable for the injection moulding operation). The shaped article obtained accordingly has good optical properties. The shaped article is subjected to various tests, with the following results.

Shaped composite - Technical properties

| | Standard method | Value | Unit |
|---|---|---|---|
| Thermal properties | | | |
| Vicat Softening Temperature | ASTM D 1525 | 93.5 | ° C. |
| (Rate B, 10N) | | | |
| Heat Distortion Temp. | ASTM D 648 | 80 | ° C. |
| (Metot B, 0.45 MPa) | | | |
| Mechanical properties | | | |
| Tensile strength at break | DIN53455 | 15 | MPa |
| Elongation at break | DIN53455 | 2 | % |
| Tensile modulus | DIN53457 | 2400 | MPa |
| Flexural strength | | 65 | MPa |
| Flexural modulus | DIN53457 | 2900 | MPa |
| Izod impact resistance, | DIN53453 | 4.0 | Kj/m² |
| notches 23° C. | | | |
| Processing conditions | | | |
| Processing temperature range | | 140-200 | ° C. |
| Mould shrinkage | | 0.8-1.23 | % |
| Tool temperature | | 40-70 | ° C. |

1. A shaped article comprising:
a three dimensional monolithic body having a composite material comprising a non-wood lignocellulosic material and a biodegradable and/or compostable polyester,
wherein the non-wood lignocellulosic material and the biodegradable and/or compostable polyester are present in a ratio of at least 1:2 and make up at least 90 wt. % of the composite material.

2. The shaped article according to claim 1, wherein the non-wood lignocellulosic material comprises network structures of cellulose, hemicellulose and lignin fibers.

3. The shaped article according to claim 1, wherein the non-wood lignocellulosic material comprises particles obtainable by grinding, milling or comminuting non-wood lignocellulosic plant material.

4. The shaped article according to claim 3, wherein the non-wood lignocellulosic plant material is an agricultural residue selected from the group consisting of flax, hemp, bagasse, straws of wheat, barley, oats, rye, rice straw, sugar cane, the stalks of maize, cotton, tobacco, bamboo, the husks or shells of grains, rice, and straws of wheat.

5. The shaped article according to claim 1, wherein the composite material comprises 40-99 wt. % by total weight of the composite material, of the non-wood lignocellulosic material.

6. The shaped article according to claim 1, wherein the composite material does not comprise polylactic acid.

7. The shaped article according to claim 1, wherein the composite material does not comprise starch.

8. The shaped article according to claim 1, wherein the biodegradable and/or compostable polyester is polybutylene adipate terephthalate (PBAT).

9. The shaped article according to claim 5, wherein the composite material comprises up to 65% by total weight of the composite material, of the biodegradable and/or compostable polyester.

10. The shaped article according to claim 1, having one or more of the following biodegradability characteristics:
biodegradation of at least 90% within a period of not more than 180 days, measured according to ISO 14855-1 (2012) under industrial composting conditions;
biodegradation of at least 90% within a period of not more than 2 years, measured according to ISO 17556 (2012) under soil compositing conditions; and
biodegradation of at least 90% within a period of not more than 1 year measured according to ISO 14855-1 (2012) under home composting conditions

11. The shaped article according to claim 1, wherein the article is a disposable article or utensil.

12. A product in the form of a granulate, a free flowing powder or a pelletized composition, said product comprising a combination of:
a particulate non-wood lignocellulosic material, said material being obtainable by grinding, milling or macerating non-wood lignocellulosic plant material; and
a particulate biodegradable and/or compostable polyester,
wherein the non-wood lignocellulosic material and the biodegradable and/or compostable polyester are present in a ratio of at least 1:2 and make up at least 90 wt. % of the granulate or powder.

13. A method of producing a shaped article as defined in claim 1, said method comprising the steps of:
a) providing a quantity of ground/comminuted non-wood lignocellulosic plant material;
b) providing a quantity of a biodegradable and/or compostable polyester;
c) mixing said ground/comminuted lignocellulosic plant material and said particulate biodegradable and/or compostable polyester and processing it into a pumpable mass; and
d) processing said mass into a shaped article.

14. The method according to claim 13, wherein step a) comprises providing a quantity of non-wood lignocellulosic plant material and processing it with a grinder, mill, sieve, or compounder to obtain a ground/comminuted material with a fiber length within the range of 0.05-3.5 mm.

15. The method according to claim 13, wherein step d) comprises die casting, injection molding, blow molding or extrusion molding of the pumpable mass.

16. The according to claim 1, wherein the kneadable mass is heated during steps c) and/or d).

17. A shaped article, said shaped article obtained by the process as defined in claim 13.

18. A shaped article comprising:
a three dimensional monolithic body having a composite material comprising a non-wood lignocellulosic material and a biodegradable and/or compostable polyhydroxyalkanoate,
wherein the composite material comprises the biodegradable and/or compostable polyhydroxyalkanoate at an amount of less than 90 wt. % based on total (dry) weight of the composite material and the non-wood lignocellulosic material and the biodegradable and/or compostable polyhydroxyalkanoate together make up at least 92.5 wt. % of the composite material.
